(19) United States
(12) Patent Application Publication
(10) Pub. No.: US 2026/0368605 A1
(43) Pub. Date: Nov. 19, 2026

(54) METHODS AND SYSTEMS FOR FAULT TOLERANT QUANTUM CIRCUIT DESIGN

(71) Applicant: ENTROPICA LABS, Singapore (SG)

(72) Inventors: Jing Hao CHAI, Singapore (SG); Ewan Franek MUNRO, Singapore (SG); Georgios SOTIROPOULOS, Singapore (SG)

(21) Appl. No.: 19/158,776

(22) PCT Filed: Feb. 27, 2024
(86) PCT No.: PCT/SG2024/050104

§ 371 Date: Aug. 21, 2025

(30) Foreign Application Priority Data
Feb. 27, 2023 (SG) 10202300505U

(51) Int. Cl. G06N 10/70

(52) U.S. Cl. CPC G06N 10/70

(57) ABSTRACT

Methods and system for quantum circuit design are provided. According to at least one aspect of the present embodiments, a computer-implemented method for enabling a user to design a quantum circuit includes presenting a user interface to the user, the user interface comprising a palette, an editor and an output display. The method also includes designing the quantum circuit in response to the user selecting one or more user interface representations of components and/or circuit operations presented in the palette and connecting a plurality of the one or more user interface representations of components and/or circuit operations in the editor in a user-assembled arrangement and computing circuit properties of the quantum circuit and displaying at least a portion of the circuit properties in the output display, wherein computing the circuit properties comprises determining if the quantum circuit is a valid quantum circuit.

### PRIORITY CLAIM

The present application claims priority to Singapore patent application 10202300505U filed on 27 Feb. 2023.

### TECHNICAL FIELD

The present invention generally relates to quantum computing, and more particularly relates to methods and systems for fault tolerant quantum circuit design.

### BACKGROUND OF THE DISCLOSURE

Quantum computers are inevitably built with noisy and imperfect components. Hence, it is important that quantum circuits are designed in a manner that is robust to noise. Such circuits are called fault-tolerant quantum circuits (FTQ circuits). FTQ circuits require a large number of qubits and components due to the requirements of building redundancies into the circuit. These extra qubits and components are additional overhead on top of the requirements for circuits designed to implement large-scale quantum algorithms. Fault tolerance is crucial for quantum computing to realise its full potential, such as exponential speedups over classical computing for certain problems.

The conventional means for designing FTQ circuits is far from optimal. The process requires a human to come up with candidate circuit designs and evaluate them by trial and error. To do so, the practitioner works with diagrammatic circuit representations, making the procedure highly visual.

In addition, any candidate circuit that the user may come up with needs to be verified to be fault-tolerant. By hand, the computations for the verification are tedious. For example, a typical fault-tolerant error-correction circuit may require one to verify upwards of 140 error locations, and consider a number of different possible errors at each location. A user needs to repeat this process of coming up with a trial circuit and verifying that it is fault-tolerant, repeatedly. In particular, to check whether a FTQ circuit has been designed correctly (i.e., whether the circuit is fault-tolerant and also performs the intended function for which it is designed), the user needs to verify a number of circuit properties. For example, for stabilizer QEC codes (one of the most commonly used families of codes), the user needs to verify whether the correct set of stabilizer operators chosen for the selected error correction scheme is maintained. Next, the user needs to verify whether the encoded logical Pauli operators are transformed correctly by the circuit, the logical Pauli operators determining whether the encoded information is transformed correctly by the circuit. And next, the user needs to verify whether a set of fault paths (i.e., the effect of errors occurring at various locations of faulty gates) can be adequately corrected.

The user needs to calculate these circuit properties both at the input and at the output of the circuit and, possibly, also at other locations in the circuit. As an example, when quantum error correction is employed in a circuit, one must perform frequent measurements and active feedback to correct any errors that may have occurred. This is achieved using a suitable error correction (EC) circuit. However, one must also ensure that the operations performed as part of the EC circuit, such as error detection and subsequent correction, do not themselves introduce errors. Thus, it is necessary to verify that the EC circuit behaves as expected even if an error occurs during the process of error correction itself. In other words, it must be determined that the EC circuit is itself fault-tolerant.

Currently, any user wishing to check whether a FTQ circuit is correctly designed must compute the relevant circuit properties by hand. However, this is only possible for the smallest circuits, typically involving no more than ten qubits. Therefore, for larger circuits, the user typically turns to a programming language (e.g. Python) to compute these circuit properties. Typically, the user has to write his/her own set of code in the programming language to perform these computations. A significant portion of the code is also typically specific to a particular candidate circuit that the user wants to check. Thus, if the user wants to check another circuit, the user may have to re-write a significant portion of the codebase. These instructions are typically “hard-coded” to each candidate circuit for a few reasons.

First, instructions are typically “hard-coded” to each candidate circuit because it is cumbersome to manage the details of large circuits in a programming language which sequences circuit operation in a linear format. The user writes a sequence of circuit operations which becomes the input for code instructions to perform the computations—however, these sequences of circuit operations are presented to the user in the linear format, i.e., as a list of sequential operations. It is not necessarily an intuitive format to work with because a FTQ circuit is typically non-linear with additional qubits being used as ancillae, such as used as blocks of qubits interacting with each other in a specific geometric pattern. In addition, some qubits leave the circuit through measurements, and those measurements are used to further influence sections of the circuits.

More specifically, a circuit can be non-linear in a number of ways. For example, a circuit may be non-linear in time such as where a flow of a circuit may have loops which repeat a certain set of circuit instructions until some condition is passed. Also, a circuit may be non-linear in a geometric sense because the underlying physical arrangement of the qubits act as a constraint in spatial dimensions. Further, a circuit may be non-linear because of more complicated or high-level encoded structures, which is typically present in error correction schemes. As encoded qubits interact, it means that at a lower level one block of physical qubits needs to interact with another block of physical qubits in a specific way. These non-linear patterns of interactions between qubits are not necessarily represented in a manner that is easy to understand at a glance in a programming language.

Another reason instructions are typically “hard-coded” to each candidate circuit is that the user has to personally handle how the circuit is converted into a representation that is suitable for the code instructions to compute the relevant circuit properties. The resulting code is typically unoptimized to handle how additional circuit components are added/deleted from the circuit, and all circuit properties have to be re-computed. The result is a workflow that is unwieldy for the user. Due to the lack of optimizations to the code and data structures, and due to how the user has to personally code the entire structure of converting the circuit into an internal representation suitable for processing, and due to the computation of the circuit properties themselves, it is more convenient usually to write code instructions that handle a specific circuit. If the user wants to check a different circuit (even if it were a minor change), the user typically adapts the codebase.

Finally, instructions are typically “hard-coded” to each candidate circuit because in a programming language, or a programming library, a workflow to design a large circuit might be needed to identify reusable parts of the circuits, and construct each part as a component of the circuit (i.e., a representation of a simple part of the circuit). The user would then write the component as a list of instructions and package it within a function. Then, the user can make as many calls to this function as he/she wishes in another circuit.

However, if the user wants to make a specific change to one of the components in a circuit, the user either has to modify the function to accommodate the exception, write another function, or simply not use the function for that portion of the circuit. This is problematic as the written function has become a “contract” such that the user must use the function in the certain way it was written. Another problem occurs when these functions are provided by standard libraries provided by companies (e.g. Qiskit) which may not allow the user to easily modify some or all of these functions.

Thus, there is a need to provide methods and systems to enable quick and user-friendly prototyping and verification of fault-tolerant quantum circuits to facilitate large-scale quantum computing. Furthermore, other desirable features will become apparent from the subsequent detailed description and the appended claims, taken in conjunction with the accompanying drawings and this background of the disclosure.

### SUMMARY

According to at least one aspect of the present embodiments, a computer-implemented method for enabling a user to design a quantum circuit is provided. The method includes presenting a user interface to the user, the user interface comprising a palette, an editor and an output display. The method also includes designing the quantum circuit in response to the user selecting one or more user interface representations of components and/or circuit operations presented in the palette and connecting a plurality of the one or more user interface representations of components and/or circuit operations in the editor in a user-assembled arrangement and computing circuit properties of the quantum circuit and displaying at least a portion of the circuit properties in the output display, wherein computing the circuit properties comprises determining if the quantum circuit is a valid quantum circuit.

According to another aspect of the present embodiments, a system for quantum circuit design is provided. The system includes an interface for user-inputting information and for presenting output information and a processing means coupled to the interface for receiving the inputted information therefrom and for sending output information for presenting on a display of the interface. The processing means is configured to present a palette, an editor and an output display on the user interface and to design a quantum circuit in response to receiving from the user interface selections of one or more user interface representations of components and/or circuit operations presented in the palette and receiving from the user interface connections of a plurality of the one or more user interface representations of components and/or circuit operations in the editor in a user-assembled arrangement. The processing means is further configured to compute circuit properties of the quantum circuit and provide display information to the user interface to display at least a portion of the circuit properties in the output display, wherein computing the circuit properties comprises determining if the quantum circuit is a valid quantum circuit.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1, comprising FIGS. 1A to 1E, depicts visual prototypes of a quantum circuit designer in accordance with the present embodiments.

FIG. 2 depicts a flowchart for quantum circuit design in accordance with the present embodiments.

FIG. 3, comprising FIGS. 3A to 3E, depicts an illustration of a surface code design process in accordance with present embodiments.

And FIG. 4, comprising FIGS. 4A to 4E, depicts an illustration of an exemplary quantum circuit design process in accordance with the present embodiments.

Skilled artisans will appreciate that elements in the figures are illustrated for simplicity and clarity and have not necessarily been depicted in full detail.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of present embodiments to provide systems and methods to promote and provide a smooth, efficient workflow where a user can easily compose quantum circuits. Thus, a quantum computing tool in accordance with present embodiments computes for the user the necessary circuit properties such as verification of fault-tolerance, and displays the circuit and the circuit properties in an intuitive and easy-to-understand visual format. The user can then utilize this output as feedback from the tool to make changes to the circuit components. For example, the user may wish to change the order of operations or components in the user-designed quantum computer circuit, or edit the sub-components of any component. The quantum computing tool in accordance with present embodiments allows these changes to be made and advantageously recomputes the target circuit properties.

In particular, the systems and methods in accordance with the present embodiments provide a quantum computing tool which enables a user to effectively design and verify fault-tolerant quantum circuits (FTQ circuits). The tool supports an iterative process in which a user can efficiently make modifications to an initial input circuit based on output properties computed by the tool. The systems and methods in accordance with the present embodiments are particularly applicable in a quantum computing system and, as discussed hereinafter, are particularly applicable to designing and verifying FTQ circuits.

While elements of the FTQ circuit problems addressed by the present embodiments can be addressed to some extent by different software tools, there is no single conventional software tool or solution available to address the entire problem and each of the different software tools have their drawbacks. Such software tools which only address fragments of FTQ circuit issues fall into three categories: visual circuit editors, quantum programming software development kits (SDKs), and high-level circuit design tools.

### Visual Circuit Editors

Currently there exist a small number of visual editors that allow users to design and prototype quantum circuits. Notable examples are: Crumble, Quirk, the IBM Quantum Composer, and Quantastica's Quantum Programming Studio. Crumble's visual interface can support up to a few hundred qubits. However, Crumble's main function is to display gate operations on a 2D grid layout of qubits with a keyboard toggle that allows the user to step forwards and backwards in time to see the gate operations at each particular instance of time. The secondary function of Crumble is to view the effect of Pauli errors on the circuit. It does not, however, compute the output state of the circuit given some input state.

The other mentioned editors support only a small number of qubits (around fifteen), which makes them inadequate for working with large FTQ circuits that necessarily require more qubits. Additionally, these editors have an output display that does not display relevant information for FTQ circuits. Either the full state representation is displayed (including probability amplitudes for each computational basis state), or the editor assumes that measurements for every qubit will take place at the end circuit and displays the probabilities for the measurement outcomes. Display of the full state representation is only useful to a user designing a circuit involving a small number of qubits. Display of probabilities for the measurement outcomes is not relevant in general for FTQ circuits, where one may not wish to measure all qubits at the end of a circuit, if, for example, those qubits are part of a larger computation. FTQ circuits are generally more complex, where some qubits at the end of the circuit are not measured because those qubits may be part of a larger computation.

### Quantum Programming SDKs

Software development kits (SDKs) oriented to quantum programming, such as IBM's Qiskit and Rigetti's pyQuil, allow users to write a list of gate operations and display the resulting quantum circuit in a visual format. However, the way circuits are edited is a problem inherited by the underlying programming language. Linear circuit sequences are easy for a computer language to process, but it is a format that ignores the inherently non-linear, geometric structures present in FTQ circuits. Moreover, if a circuit is found to violate desired conditions (e.g., being fault-tolerant based on properties calculated at the output), a linear display of the circuit's instructions is poorly suited for purposes of debugging and identifying necessary changes to the circuit.

### High-level Circuit Design Tools

High-level circuit design tools are more focused on designing high-level quantum algorithms and do not currently take fault-tolerance into account. Two examples of such tools are Classiq's Quantum Algorithm Design tool and Quantastica's Quantum Algorithm Generator.

Classiq's Quantum Algorithm Design tool is oriented towards allowing a user to quickly put predefined high-level functions together to construct a quantum algorithm. For example, a user may specify as input to a program that they want to solve a combinatorial optimization problem with some set of constraints and to a certain target accuracy. Classiq's tool then algorithmically searches for a quantum circuit that satisfies the user's requirements. However, this circuit search does not incorporate the additional circuit elements required for fault-tolerance and error correction; it merely returns a logical-level circuit implementing the computation assuming a perfectly noiseless quantum computer will be used.

Quantastica's Quantum Algorithm Generator focuses on generating circuits using machine learning (ML). Their website provides a video demonstration of an example where their ML model “learnt” the form of a circuit that could perform the quantum Fourier transform. However, as with Classiq, Quantastica's tool produces logical-level circuits without taking into account the error correction and fault tolerance necessary to operate in a quantum computing environment.

A suitable programming language or library can also be used to create a simulator for FTQ circuits. However, these languages or libraries are usually created for specialized use-cases. One example is Stim, a Python library that provides a fast simulator (written in C++) for noisy FTQ circuits. However, a simulator is only one element of the toolchain required for designing, discovering, and analyzing FTQ circuits.

Thus, it can be seen that one of the main challenges in crafting FTQ circuits is that there is no single tool allowing one to perform the interactive, end-to-end task of designing, analyzing, and prototyping such FTQ circuits. To do all of these things with existing solutions, a user must switch between different tools, each of which provides an element of the total set of functionalities required. This fragments the user workflow, introducing friction and inefficiency because the input and output of the existing tools do not necessarily align together smoothly, and because several key elements required for FTQ circuit design are not provided by any existing tool.

### Definitions

For the description of the methods and systems in accordance with the present embodiments hereinafter, it is necessary to define certain terms.

Circuit will be understood to mean ‘quantum circuit’, unless otherwise stated.

Low-level components refer to suitable abstractions that represent a simple part of a FTQ circuit. A low-level component could be a basic circuit operation such as the Hadamard gate or the CNOT gate that has a specific and simple function, but can also refer to a sub-circuit such as a syndrome-measurement circuit whose primary purpose is to measure the eigenvalue associated with a stabilizer operator of a quantum error correction (QEC) code. Some of these low-level components could also be designed/specified by the user, thus a user can build FTQ circuits of higher and higher complexity through a ground-up approach.

Hard-reset for a qubit refers to setting such a qubit to the ground state, or some reference state, such that there is high probability to expect the qubit would be in the ground state after the reset. Due to the high expectation for the state of the reset qubit, extra steps may be taken in the process. Therefore, the time it takes to perform a hard-reset can be long which makes it unsuitable to be used in scenarios where a fresh qubit in the ground state needs to be readily and quickly available again.

Error correction will refer to ‘quantum error correction’ unless otherwise stated.

A logical qubit is a type of encoded qubit that has the property that its state is protected by a quantum error correction code.

A quantum error-correction code is an encoding of quantum information into a larger Hilbert space, by, for example, using multiple qubits, with the purpose to be able to remove errors due to noise on the physical systems from encoded information, thus protecting the information to a certain degree from the corrupting effects of noise.

A Component (with upper-case “C”) refers to a representation of a simple part of the circuit, within the tool itself. Where the word ‘component’ (with lower-case “c”) appears, it has its everyday meaning. By connecting various Components to each other, a user designs a FTQ circuit. A Component takes as input some quantum information (qubits) and classical information (bits), changing those inputs in some way, and outputting the results as some other quantum and classical information. The simplest Component consists of only itself, and is used to represent simple gate operations that act on basic units of quantum information or classical information in a pre-defined way.

A component of the tool refers to a part of the tool such as the Simulator or the Converters or the User Interface as discussed hereinafter.

A component of a quantum circuit refers to various parts that make up such a circuit, including qubits, measurements, simple gate operations (single-qubit, two-qubit), but can also include other classical control capabilities needed to drive the circuit.

A physical qubit is defined as the basic unit of quantum information that is implemented at the level of hardware, which for physical systems can include superconducting qubits, trapped ions, neutral atoms, silicon quantum dots. When properly implemented, the state of such systems can be described to a good degree of approximation by Pauli algebra. Also, when properly implemented, all possible states in this space should be reachable to a sufficiently high fidelity via physical operations.

Physical operations are physical processes that are used to control or change the state of physical qubits. These processes can vary depending on the type of hardware. For example, the physical processes can include microwave pulses or laser beams. Physical operations can be combined in different combinations to form gate operations. Quantum information can also be encoded from collections of physical qubits in a way such that the encoded state behaves like a qubit itself. And, in general, such encodings are done so as to give the encoded qubits certain properties, such as to either be more easily manipulated or be more robust to a certain type of noise.

A logical operation is an operation that changes the state of the logical qubit in the same way as a physical operation changes the state of physical qubits. The difference is that since a logical qubit is usually composed of many physical qubits, a logical operation is itself composed of many physical operations.

### Present Embodiments

The methods and systems in accordance with the present embodiments advantageously provide users an efficient workflow to quickly prototype FTQ circuits from low-level components utilizing a visual interface and, beneficially, achieved without the need for the user to switch to other platforms or tools. Key features of the methods and systems in accordance with the present embodiments which enable solution of the conventional problems identified hereinabove include the following:
A. The circuit itself and the relevant circuit properties are displayed in a visual format that is intuitive for the user to understand as illustrated in scenarios discussed herein.
B. The circuit itself can be easily modified in that users can add or delete any Component at any point in the circuit. In addition, the details of sub-Components (as defined hereinbelow) can also be edited.
C. The methods and systems handle the task of computing relevant circuit properties for the user. This can be achieved through predefined and in-built functions or through custom functions written by the user. The tool then converts relevant information about these computations into part of the visual representation of the circuit, or makes recommendations so that the user can intuitively understand the results of the computations. The relevant circuit properties that the tool in accordance with the present embodiments can compute include numerical or mathematical properties of the circuit output state, or of important objects at the output. A non-exhaustive list of such properties includes the stabilizer representation of the output state (i.e., the output of the circuit), the effective errors at the output due to faults in the circuit, the expectation value of observables, and correlation functions. The relevant circuit properties that the tool in accordance with the present embodiments can compute also include whether or not the circuit as a whole is fault-tolerant and circuit compilation details necessary due to the constraints of specific hardware platforms. Examples of such circuit compilations include qubit selection and mapping solutions, and qubit routing schedules. The relevant circuit properties that the tool in accordance with the present embodiments can compute also include the mathematical form of the logical Pauli operators for a given error correction scheme or for a fault-tolerant implementation of the circuit (with or without specifying a target device) and the transformation of logical information encoded across multiple qubits when acted upon by a circuit or circuit Component. For example, the tool in accordance with the present embodiments can indicate to the user if a candidate encoded gate operation (e.g., an encoded CNOT gate) transforms an encoded qubit or a set of qubits in the manner intended or expected.
D. Any circuit designed by the user could become a Component to be used in larger circuits. A user-designed Component is then treated as a single object focusing on input and output of arbitrary numbers of qubits, while its internal composition could be formed from multiple objects interacting with each other. In this way, the user can manipulate such a single object while effectively manipulating as a whole all of the underlying parts at the same time. The tool can be designed to provide the user with a predefined bank of basic Components commonly used in error correction schemes, conveniently provided as visual representations. Basic Components could include single-qubit Clifford gates, such as the Hadamard gate, Pauli Gates, and the phase gate; two-qubit Clifford gates, such as CNOT, SWAP, and CZ; stochastic versions of single-qubit and two-qubit Clifford operations; state initialization for stabilizer states, hard measurement (i.e., qubit state is hard-reset) states, and soft measurement states (i.e., qubit state may not be hard-reset); conditional branch Components; Components that store classical variables such as integers, floats, complex numbers, arrays, or more complex data structures such as sets, dictionaries, or graphs; and output Components, such as expectation values of certain observables with respect to certain sets of qubits and time-evolved operators (i.e., for instance, for an operator originally specified at time T₁ of the circuit, compute its form at time T₂ of the circuit). These examples of basic Components focus on Clifford gates and stabilizer states because these Components are most useful for development of error correction circuits. Limiting basic Components to this set of gate operations and stabilizer states allows the tool to go beyond the current qubit limitations in FTQ circuit simulation of around fifteen qubits, but prevents the user from exploring a more general class of circuits. Nevertheless, Components implementing more general quantum operations can also be used in accordance with the present embodiments.
E. The tool can advantageously make suggestions on how circuits could be designed. The suggestions can be in the form of tutorials that not only teach the workflow provided by the tool, but also to teach and illustrate simple examples of FTQ circuits. As a more advanced example of the tool's capabilities in accordance with the methods and systems of the present embodiments is that the tool can infer a possible intent of the user in designing some circuit and make suggestions either as a simple working circuit or to point out possible areas of improvement. That is, the tool could be trained using suitable methods and data to assist the user in achieving his or her goals. The tool making suggestions is an option that can be selected by the user.
F. The tool handles logical abstraction, whereby encoded qubits which carry quantum information encoded using a collection of physical qubits are represented and manipulated as a single unit of information, once the user has successfully set up a circuit to produce and maintain such encoded qubits. The tool thus abstracts the working unit of quantum information, handling for the user the necessary computations with underlying components and structure.
G. The tool provides visual abstraction of circuit Components and operations. This allows the user to focus on details at multiple layers of relevance, ranging from single gate operations (where no visual abstraction is applied) to large groups of operations performing a specific function within the circuit (requiring significant visual abstraction). For example, repetitive circuit components can be applied in a more intuitive manner by blocks that hide irrelevant details and focus on visually relevant information. For instance, a syndrome measurement circuit of an observable could be represented by a colored square acting on the affected qubits. In a large QEC circuit such as the surface code, the visually relevant information concerns which qubits are affected and the less relevant information are details of the syndrome measurement circuit itself. Or large QEC circuits may be subdivided into portions where each portion performs a particular high-level function, such as a QEC circuit that may require a supply of high-quality ancilla states. A portion of the circuit may therefore be designated as an “ancilla factory”. In a large circuit where the user does not need to see all details simultaneously, the ancilla factory may simply be represented by a suitably labelled box.

The seven key features (A to G) of the tool in accordance with present embodiments provide methods and systems for a user-friendly quantum circuit design environment for swift and efficient FTQ circuit design in accordance with the present embodiments.

The methods and systems in accordance with the present embodiments focuses on fault-tolerant aspects and structure of circuits by enabling a user to insert errors into a point in the circuit and visualize the effect of that error. Circuit properties relevant to fault-tolerance and error correction are also computed in the background and returned to the user in accordance with the methods and systems of the present embodiments, advantageously handling these tedious computations for the user. This allows the user to focus on the sole task of designing the circuit, swapping circuit components as he/she sees fit based on feedback and results automatically generated by the tool in accordance with the methods and system of the present embodiments.

The methods and systems in accordance with the present embodiments include a visual hands-on workflow and a software tool that implements this workflow. In accordance with the present embodiments, the components of the tool include one or more Simulators; Components; Converters; and a User Interface including a Palette, an Editor, and an Output Display.

The Simulator is a component that simulates the transformation performed by the quantum circuit on the input state, resulting in the circuit output state. The Simulator can have different embodiments depending on the mathematical representation of the quantum state being used, such as a full wavefunction (wavevector) Simulator, a Stabilizer state Simulator, a tensor network Simulator, and a ZX calculus Simulator.

The representation—and hence the Simulator—used will depend on the user's goals. For example, in some applications the user may not need the full output quantum state but only certain properties of the output quantum state. Examples of such properties include measurable observables or effective noise operators. In these cases, a fast and scalable simulation method, such as a Stabilizer state Simulator, may be used. For additional speed, the Simulator can be coded in an efficient programming language in order to handle very large and complex simulations, while parallel processing (either multi-threading or GPU processing) can be used to handle the simulations.

The Simulator used to compute the relevant Output could be based on any efficient representation of large FTQ circuits (e.g., the backend could swap between different representations such as tensor networks and ZX calculus). Different representations bear different advantages such as working well in specific regimes of numbers of qubits or being able to compute certain circuit properties efficiently. It is conceivable that neural networks could be included and trained to mimic the output of certain classes of FTQ circuits. When sufficiently large quantum computers become available, some of the Output may be computed by such computers.

A Component takes as input some quantum and classical information, changes those inputs in some way, and outputs the results as quantum and classical information. The simplest Component consists of only itself and is used to represent simple gate operations that act on basic units of quantum information (qubits) or classical information (bits) in a pre-defined way. A general Component can be made up of Components (which are then called sub-Components with respect to the Component) connected amongst themselves in a directed manner. The rules for how sub-Components are connected are (a) a quantum input to a sub-Component must either come from some qubit(s), the quantum input of the parent Component, or from the quantum output of another sub-Component (which could be itself); (b) likewise, a classical input to a sub-Component must either come from some bit(s), the classical input of the parent Component, or from the classical output of another sub-Component (which could be itself); (c) a quantum output from a sub-Component must be connected to either the quantum output of the parent Component, or the quantum input of another sub-Component (which could be itself); and (d) a classical output from a sub-Component must be connected to either the classical output of the parent Component, or the classical output of another Sub-Component (which could be itself).

As previously mentioned, basic Components may include single-qubit Clifford gates, such as the Hadamard gate, Pauli Gates, and the phase gate; two-qubit Clifford gates, such as CNOT, SWAP, and CZ; stochastic versions of single-qubit and two-qubit Clifford operations; state initialization for stabilizer states such as hard measurement (qubit state is hard-reset) or soft measurement (qubit state may not be hard-reset) states; conditional branch Components; Components that store classical variables such as integers, floats, complex numbers, arrays, or more complex data structures such as sets, dictionaries, or graphs; and output Components, such as expectation values of certain observables with respect to certain sets of qubits or time-evolved operators.

A Root Data Representation (RDR) is the fundamental data structure that is used in the methods and systems in accordance with the present embodiments to represent all creations by the user. A possible form of the RDR data structure is a directed graph, where the nodes of the graph hold information about Components and the directed edges specify how nodes are connected to each other and the direction of information flow. Within each node, similar graphs can be stored as well, in order to accommodate arbitrarily complex Components.

Converters change the RDR into other types of data for different uses. A list of some of the most significant Converters include a Visualization Converter, a Simulation Converter, and an Expectation Value Converter.

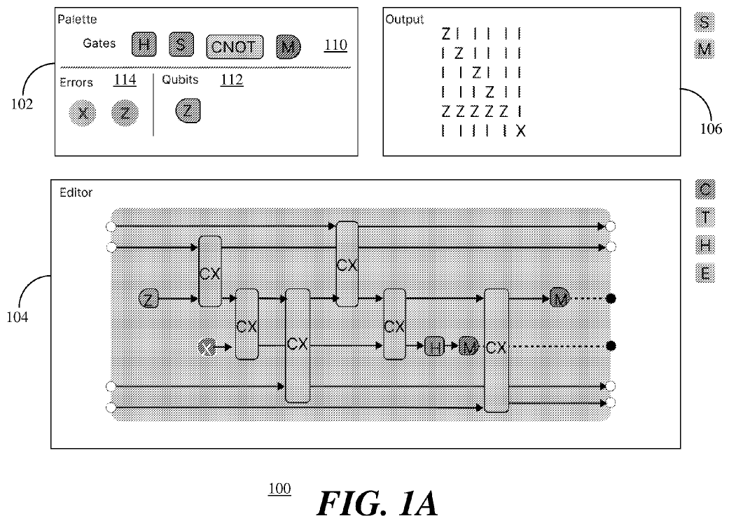

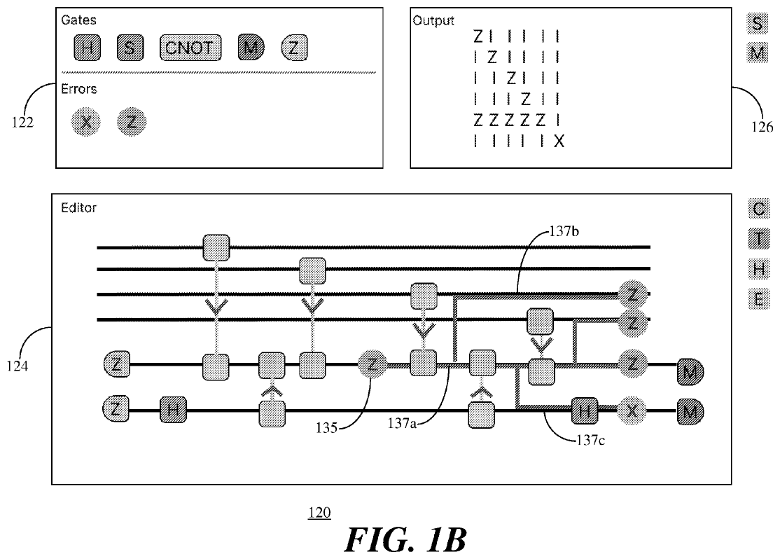

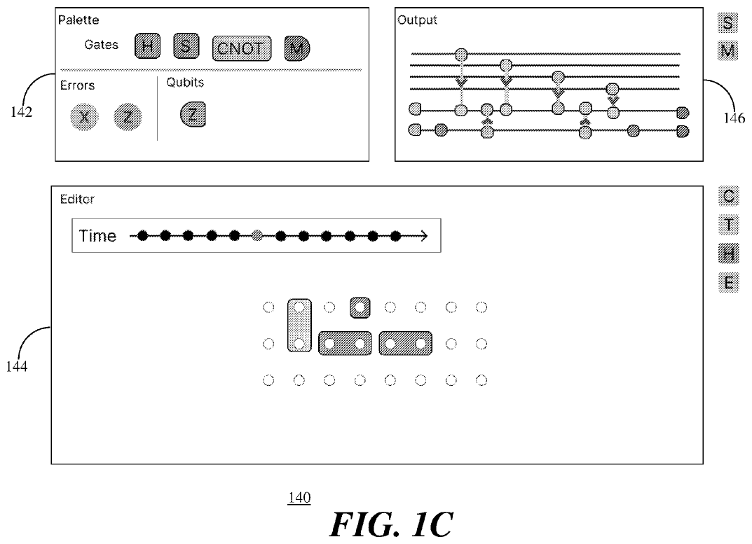

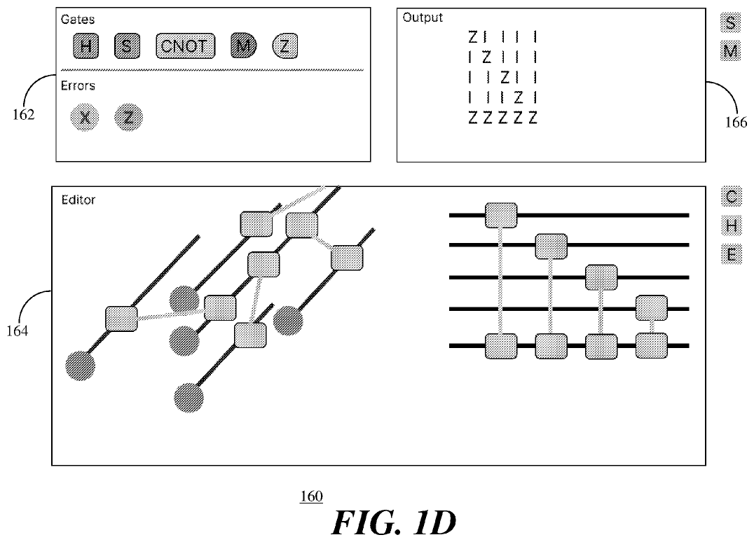

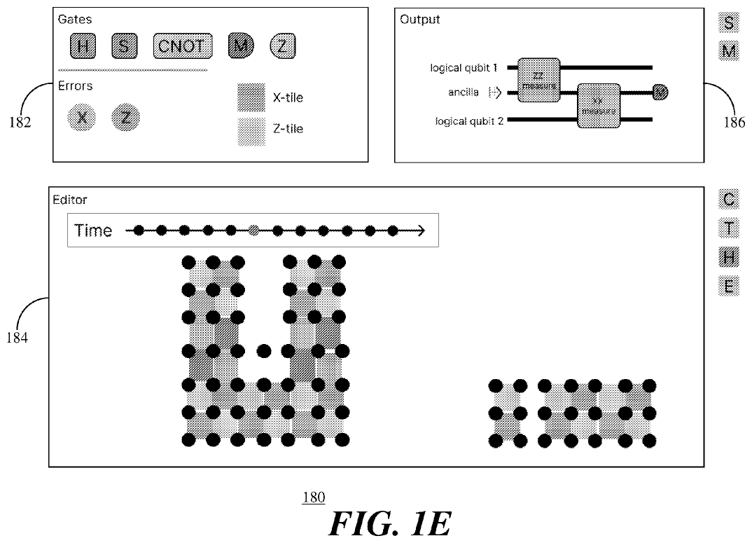

The frontend with which the user interacts is the User Interface, an application that has a graphical user interface (GUI) and includes three subcomponents: the Palette, the Editor, and the Output Display. Referring to FIGS. 1A to 1E, respective illustrations 100, 120, 140, 160, 180 depict visual prototypes of a User Interface in accordance with the present embodiments.

In the illustration 100 of FIG. 1A, an example User Interface design of a Palette 102 is illustrated. The Palette 102 includes User Interface (UI) elements, such as representations of circuit operations, that a user can drag and drop onto the Editor 104. The Palette 102 can also include Components that have been designed by the user, copies of which can be dragged by the user and dropped onto the Editor 104. In addition, the Palette 102 includes key UI representations for simple operations such as gate operations 110, qubit state initialization and preparation 112, and classical control elements to help the user build more complex Components, and UI representations for standard Components like error-correction circuits 114 for some standard schemes that the user can explore. The visual representation of the state initialization and preparation 112 in FIG. 1A indicates preparing a qubit that is stabilized by the +Z operator (i.e., a qubit in state |0>).

The Palette 102, 122, 142, 162, 182 can be in different variants. For example, the Palette (such as the Palette 102) can be a UI zone in the GUI where visual representations of circuit gates (such as the gates 110) are displayed. A typical workflow begins with the user dragging Components from the Palette 102 into the Editor 104 and arranging them according to the user's needs. Another example of the Palette is a UI bar (a hotbar) where circuit Components are listed and represented visually. The hotbar is connected to the user's keyboard, whereby the keys 0-9 allow the user to switch the “currently active” Component. The currently active Component is a component for which the user can repeatedly place copies into the Editor with simply a single mouse click. A proficient user in this workflow of placing Components with mouse-clicks and switching Components with keyboard keys can design large circuits swiftly. And the user can edit which Component he/she would like to be held in the hotbar. In a third variant of the Palette, a mouse-press or a keyboard press could call up a UI zone in the GUI where the user can then switch the currently active Components. The difference between this variant and the previous variant is that the hotbar is constrained to only nine items at any moment in time in the previous variant (until the user edits the hotbar manually again), while in this third variant, the UI zone that appears is not constrained in this way. The cost is two additional mouse-press/key presses.

The core feature of the Editor 104, 124, 144, 164, 184 is that the Editor is a space where the position of UI elements representing Components can be re-arranged by the user relative to each other and their connections to each other changed. In the Editor, Components can be added or deleted, and the internal compositions can be changed by the user. Components that query circuit properties at some locations of the circuit can be used by the user to specify the type of output in the Output Display 106, 126, 146, 166, 186. There are also buttons that toggle views of different representations of the FTQ circuits. One view could be the two-dimensional canonical circuit-view where the circuit depicts how input states on the left-side of the figure are transformed into output states on the right-side of the figure by a sequence of Components. In this view (shown in the Editor 124, FIG. 1B), the spatial relationship between qubits (if a specific target quantum computer is specified) is not shown, but the time-sequence of the Components in relation to each other are clearly displayed. A second view could be a three-dimensional view where the base layer consists of a two-dimensional layout of physical qubits, and the third dimensional represents time. Successive layers then depict the sequence of the gates. In this view (shown in the Editor 164, FIG. 1D), the geometric relationship of an array of physical qubits is clearly emphasized. A three-dimensional view could also be replaced by a view that switches between displays of each two-dimensional layer with a button/key-press (see FIGS. 4B to 4D described hereinafter).

A third view could be a hybrid of the previous two views, consisting of the second view as the primary view, with the first view as the secondary displayed in a smaller window. Both views are displaying the same circuit that is currently edited by the user. An example is depicted in the illustration 160 (FIG. 1D), where the second view is shown on a separate area in the Editor 164. A fourth view could be how the user edits Components, to assemble large FTQ circuits. The illustration 100 (FIG. 1A) depicts an Editor 104 in which the user is designing a Component that can be used as part of a larger FTQ circuit.

Additionally, certain Output can be converted into a visual representation and overlaid onto a visual representation of the circuit. For example, if the tool has computed an effective error at the end of the circuit, maybe because the user was investigating the consequence of introducing a fault at some point inside the circuit, the effective error maybe converted to a visual representation as a colored path, overlaid on top the visual representation of the circuit in two-dimensional canonical circuit-view. This is depicted in the Editor 124 in the illustration 120 where the effect of a Z error 135 is illustrated by a thicker line 137a, 137b, 137c as it spreads through the circuit.

The Output display 106, 126, 146, 166, 186 in the illustrations 100, 120, 140, 160, 180 will show the different circuit properties of the FTQ circuit displayed in the Editor, as computed by the backend. Some of the different outputs can be displayed in this space. Some of the most relevant, but not all of the possible, different outputs are: the stabilizer representation of the state of the qubits at a particular time of the circuit (such a display is useful for designing error correction circuits—see the Output 146 (FIG. 1C)); the effective error at any point of the circuit due to a fault introduced by the user into the circuit; a measurement output (see the Output 186 (FIG. 1E), if there were measurement components in the circuit; and whether the circuit satisfies all conditions to be fault-tolerant, and if not, why.

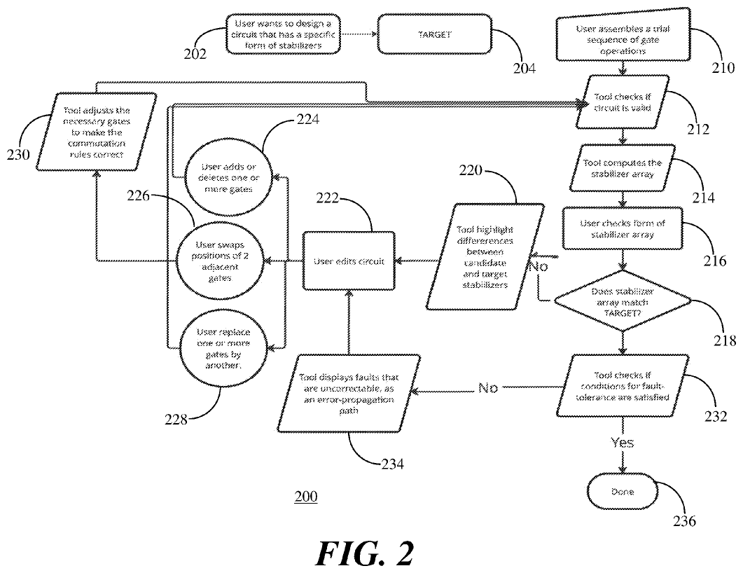

Referring to FIG. 2, a flowchart 200 depicts a method for quantum circuit design in accordance with the present embodiments. When a user wants to design 202 a circuit that has a specific form of stabilizers, the user identifies 204 a specific target stabilizer array. Then the user accesses the tool and assembles 210 a trial sequence of gate operations. The tool determines 212 that the circuit is valid and computes 214 the stabilizer array. The user checks 216 the form of the stabilizer array and the tool determines 218 whether the stabilizer array matches the target 204.

When the tool determines 218 that the stabilizer array does not match the target 204, the tool highlights 220 the differences between the candidate stabilizers and the target stabilizers. The user then edits 222 the circuit by the user adding or deleting 224 one or more gates, or the user swapping 226 positions of two adjacent gates, or the user replacing 228 one or more gates by other gate(s).

After the user adds or deletes 224 one or more gates or replaces 228 one or more gates, the tool determines 212 that the circuit is valid and computes 214 the revised stabilizer array. After the user swaps 226 the positions of the two adjacent gates, the tool adjusts 230 the necessary gates to make the commutations rules correct and then returns to determine 212 that the circuit is valid and compute 214 the revised stabilizer array.

When the tool determines 218 that the stabilizer array matches the target 204, the tool checks 232 if the conditions for fault-tolerance are satisfied. When the conditions for fault-tolerance are not satisfied 232, the tool displays 234 the faults that are uncorrectable as an error propagation path (e.g., the line 137a, 137b, 137c in FIG. 1B) to assist the user to edit 222 the circuit. When the conditions for fault-tolerance are satisfied 232, the quantum circuit matches the target 204 and is fault-tolerant, so the process is done 236.

Hereinafter, the operation of the tool in accordance with the present embodiments is described as a workflow from an input to an output. The fundamental information contained in the input is a quantum circuit, i.e., a concrete sequence of standard quantum gate operations along with any parameters associated to them (e.g., rotation angles), and the qubits upon which they act. A topology (i.e. a list of qubits between which entangling gates can be applied directly) for a specific quantum computer may also be provided. Additionally, a specific quantum error-correction code can be part of the input as well.

The user may enter input information to the tool by using the Palette (as described hereinabove with reference to FIGS. 1A to 1E) and the tool's drag-and-drop feature; or by programmatically using a standard quantum programming language such as, but not limited to, Qiskit, Cirq, Braket, Q#, or a standard general-purpose programming language such as Python or Julia; or by a standard file format such as, but not limited to, JSON, or a text file; or by text fields provided in the tool.

In regards to the output, it is necessary to make the following distinctions in the word ‘output’: ‘output’ (lower-case o) is used without any specific meaning other than its everyday meaning, while ‘Output’ (upper-case O) refers to all forms of output from the tool, including everything in the User Interface, and any data saved to a file or returned by other means. The term ‘Output Display’ refers to a specific component of the User Interface, such as the Output Display 106 of FIG. 1A. For brevity the ‘Output Display’ may be labelled as ‘Output’ in the figures, however the general meaning of ‘Output’within this description refers to all forms of output from the tool.

Several things are obtained as output. A visual representation of the circuit, where circuit components are graphically arranged relative to each other in a way that corresponds to the specification of the circuit. In FIG. 4A, as described hereinbelow, in the space specified as ‘Editor’, an example illustration is depicted where the concept is that the user can arrange and connect Components and one of the possible outputs of the tool is to display the resulting circuit in another visual representation as shown in the part labelled ‘Output Display’. Components can be built up from simpler Components, and complex circuits can be built in this way. In FIGS. 4B to 4E, the user is editing the circuit in one visual representation in the Editor and viewing the same circuit in another visual representation in the Output Display.

The output can also include a visual depiction of how a circuit responds to the effect of errors. In FIG. 1B, for example, the user has placed an error in the circuit (the Z operation 135) depicted in the Editor 124. The tool displays in the lines 137a, 137b, 137c how the error propagates through the circuit, and in the Output Display 126, the final form of the error at the output of the circuit is shown.

The output can also include a visual depiction of whether a circuit is fault-tolerant. The specific conditions used to make this determination are encoded in a verifier module, called the FT Verifier. Conventional conditions are known to those skilled in the art, however alternatives may also be used—the methods and systems in accordance with the present embodiments can be used with any suitable FT Verifier.

And the output can also include a high-level representation (or abstraction) of the circuit. For example, a possible abstraction of a circuit replaces the details of an error-correction circuit by a module that focuses on only the input and output in terms of the encoded information. For example, in FIG. 1E, the user is editing the circuit at the level of physical qubits. The tool computes the effective operation on the encoded qubits, and displays this operation to the user in the Output Display 186.

The user may receive the Output in various ways, including receiving a presentation of a display of the circuit in various representations in the graphical user interface, such as within the Editor; receiving a suitable visual representation of the circuit in a graphics format, such as PNG, SVG, PDF, or HTML; displaying the circuit properties in the Output display and, possibly, printing the information to a file format, such as a text file or a JSON file; or converting the circuit's full instruction sequence to another common quantum programming platform, such as Qiskit, Cirq, Braket, or Q#.

The tool processes the various forms of input to a visual representation of the circuit that is displayed in the Editor. If the circuit was provided in a standard quantum/general-purpose programming language, or in the form of the standard file format, the tool translates this into a visual representation in the Editor. If the circuit was constructed by the user through the drag-and-drop feature, then the circuit is already visually displayed in the Editor.

The tool has an internal representation of a quantum circuit, which we refer to as the Root Data Representation (RDR) as described hereinabove. The RDR is a data structure designed to capture and represent the flow of information (both qubits and classical bits) from a beginning to an end. The RDR is used as the basic circuit representation from which other representations are constructed for different purposes. The job of turning the RDR into a different representation is performed by a Converter, of which important examples include a Visualization Converter, a Simulation Converter and an Expectation Value Converter. The Visualization Converter translates the RDR into different visual representations of the circuit according to the needs of the user, depending on the type of circuit that the user wants to design. The Simulation Converter converts the RDR into a data representation that is optimized for fast simulation of the quantum circuit, where the software tool calculates the action of the quantum circuit after which the data structures optimized for fast simulation of the circuit are passed to the Simulator. Expectation Value Converters can be used to transform the RDR into a data format suited to the fast computation of a desired expectation value in the case where a full simulation of the circuit is not necessary

The Simulator performs the computations to compute the output state of the circuit, where ‘output state’ refers to the outcome of the quantum circuit in whichever mathematical representation is being used (e.g., the wavefunction/wave-vector, the density matrix, or the stabilizer state). From the output state, physical quantities of interest to the user can be computed, such as the state of an individual qubit or the reduced state of a group of qubits or the effective error occurring at the output resulting from the occurrence of an error or errors at some location or during some gate operation(s) in the circuit.

These quantities are formatted or transformed into a visual representation that is easy for the user to understand and which is displayed in the tool's Output. For example, the display may show the effective error at a continuous sequence of times in the circuit as a colored pathway in the circuit, thereby showing how an error propagates through the circuit.

The user can then check the Output, to see if the target objective has been met, for example to obtain a specific piece of output data such as an expectation value or to design/create a circuit satisfying some desired criteria such as fault-tolerance. If the objective is achieved, the user can stop. There is an option in the tool to produce Output in the form of a circuit diagram in one of the digital image formats (e.g., PNG, or SVG) and also as a sequence of circuit instructions in another quantum programming library, (e.g., Qiskit, Q#or Circ). In this form, the user can then transfer the output to another tool, such as to send the circuit instructions to hardware or to utilize specific capabilities in another quantum programming library.

If the user wishes to continue editing their creation, this can be achieved by adding/deleting/changing circuit components in the Editor, and the tool updates the Output accordingly. This workflow can continue indefinitely until the user is satisfied with the results.

The tool can be run locally on the user's machine either as a web application or as a standalone application. It could also be run on remote servers and the results delivered to the user's machine. When sufficiently large quantum computers are available, these circuits could also be executed directly on real quantum computers (instead of simulators) with the results delivered back to the user.

The user can save their work, and continue at another time. The tool in accordance with the methods and systems of the present embodiments generates a standard file format which is a record of key parameters and representation of the FTQ circuit design in the Editor as well as a snapshot of the state of the Palette. Users can load these saved files on their local machines, but more critically, any user can load up these saved files on their own local machines.

In order for the user to save progress and continue at a later time, the tool in accordance with the methods and systems of the present embodiments writes to a file the following data: the state of the Palette which may contain Components that the user have designed, the internal data representation for the FTQ circuit currently displayed in the Editor, and the data displayed in the Output Display or any other Output data that is overlaid as visual information in the Editor.

The user has the choice to switch between different variants of the User Interface. Alternatively, the tool could end up with only the one variant of the User interface described herein. For the Editor, to facilitate the arrangement of Components, the Components may “snap” to certain grid points in the space or align to nearby components. The Editor could have split-screen functionality, so that the user can work on different parts of the circuit at the same time, or display two different visual representations of the circuit at the same time. The Output Display could be customized by the user to display quantities that are relevant to the user. In addition, the tool could have certain programmable modules to allow the user to put together a custom computation to compute a quantity of interest. The tool could also accept specifications of a given quantum computer as input from the user, such as the execution time for different gates, the gate error rates, and coherence times. This information could be used to estimate the total probabilities of different errors occurring with different multiplicities.

The primary advantage provided by the methods and systems in accordance with the present embodiments is the efficient workflow for fast prototyping of quantum circuits. This lends itself to scaling to design large FTQ circuits. A simple example is as follows: Suppose that the user has created a small circuit and has saved it as a Component inside the Palette of the tool. The user can then pull copies of the Component out into the Editor and compose, arrange, and connect the copies of the Component as desired.

Suppose the user next wishes to make changes to one of the Components, for example to add or delete a sub-Component. The user would be able to do so easily, because the tool allows the user to arbitrarily change any Component. Moreover, each instantiated copy of the Component is its own version and can therefore be modified independently of the other copies.

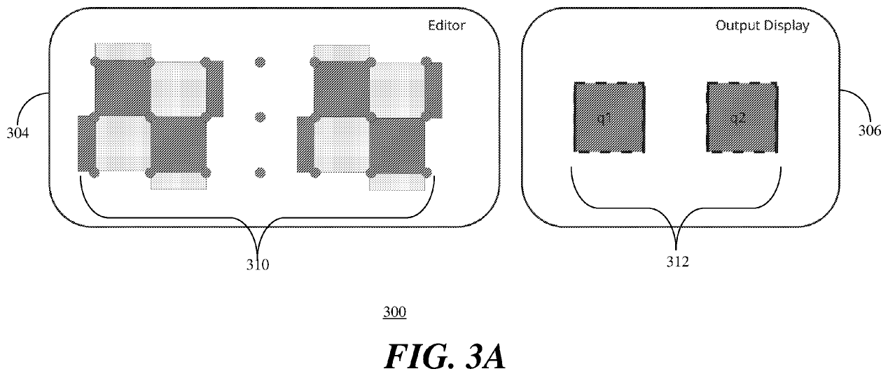

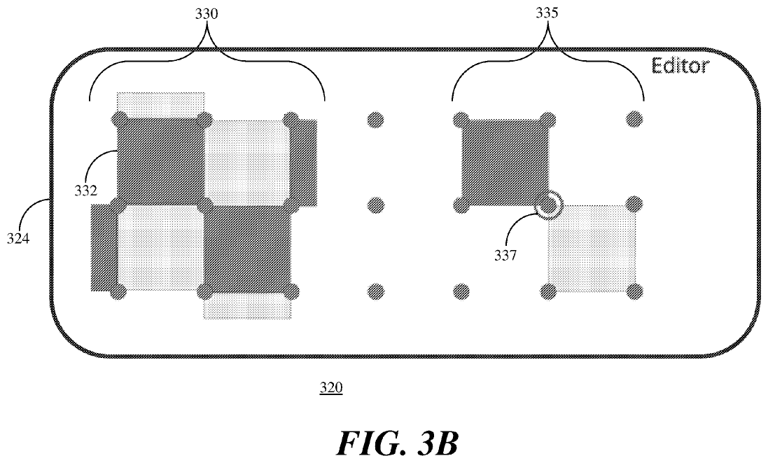

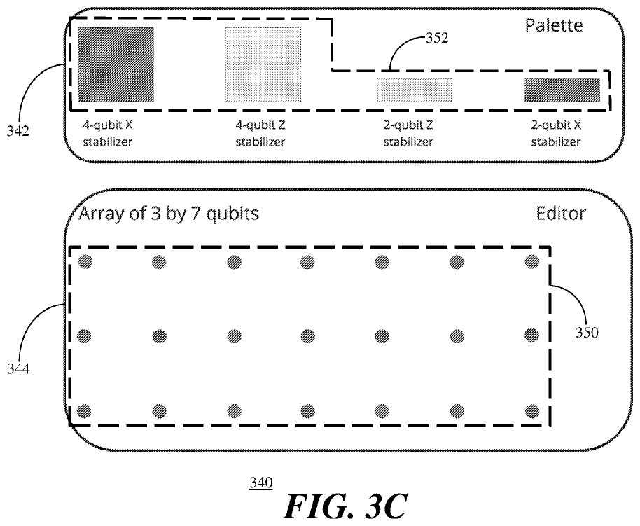

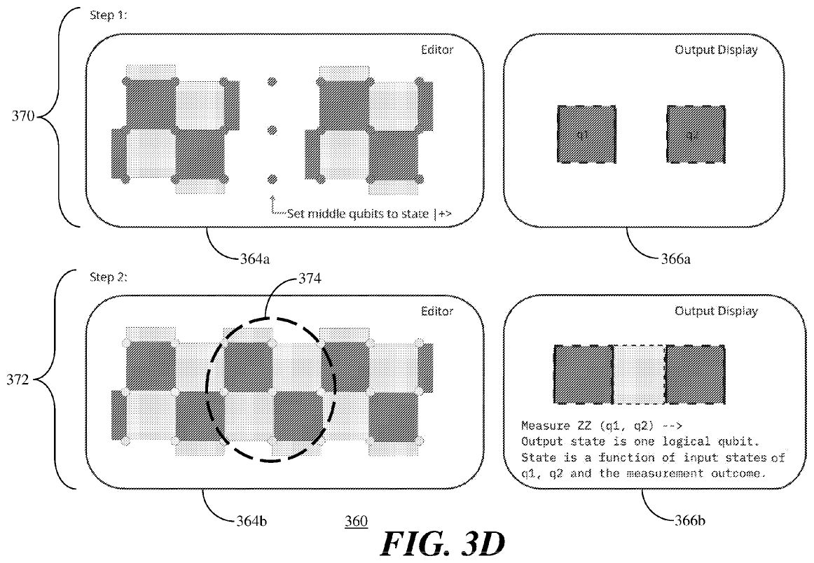

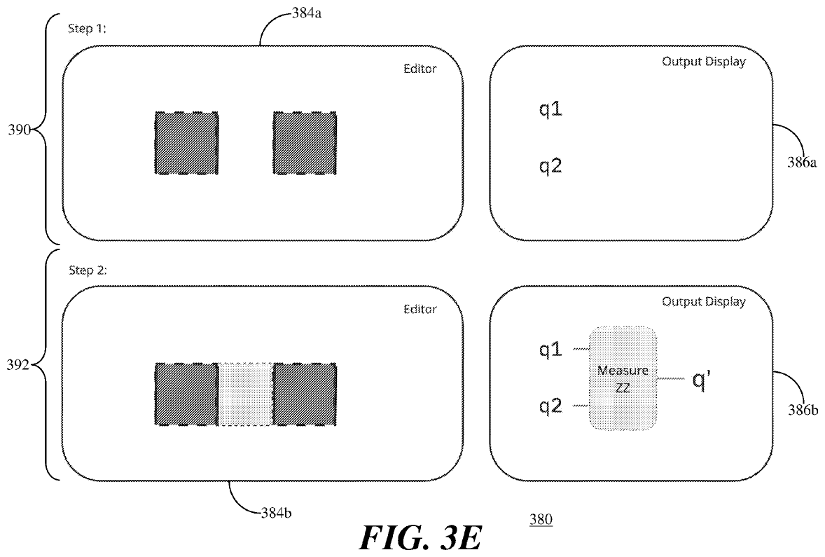

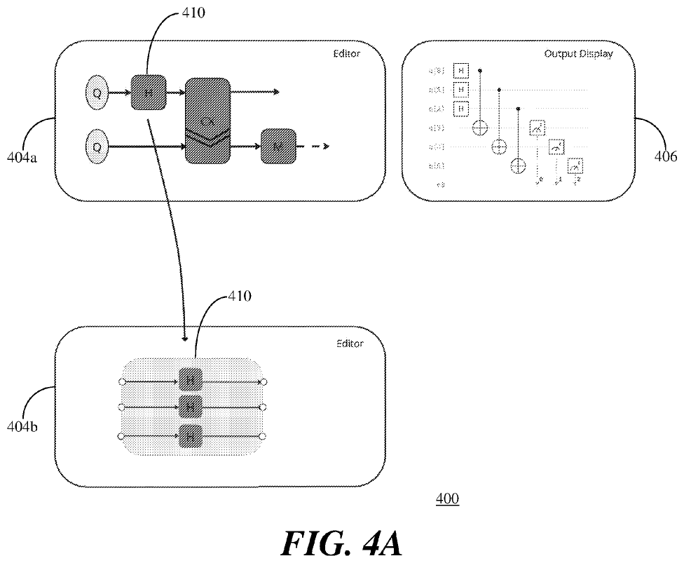

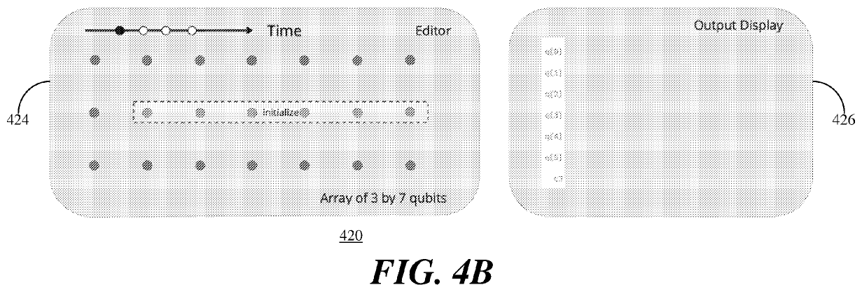

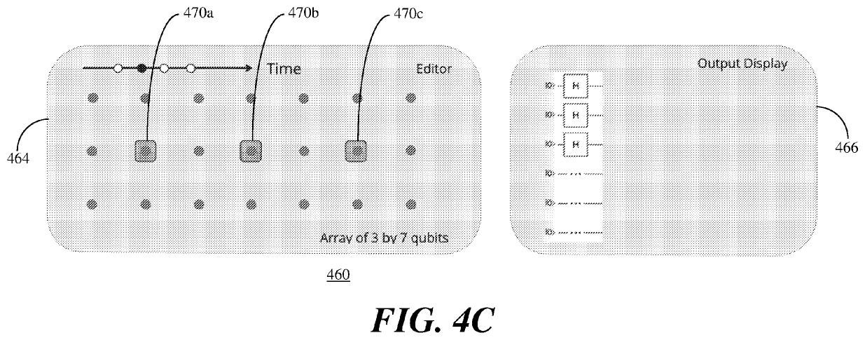

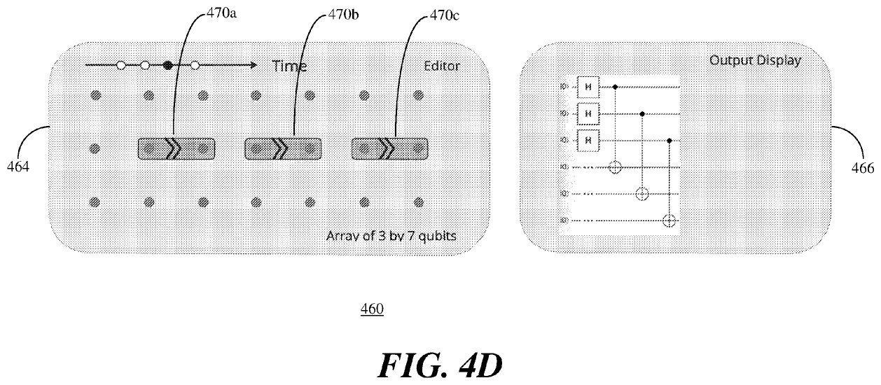

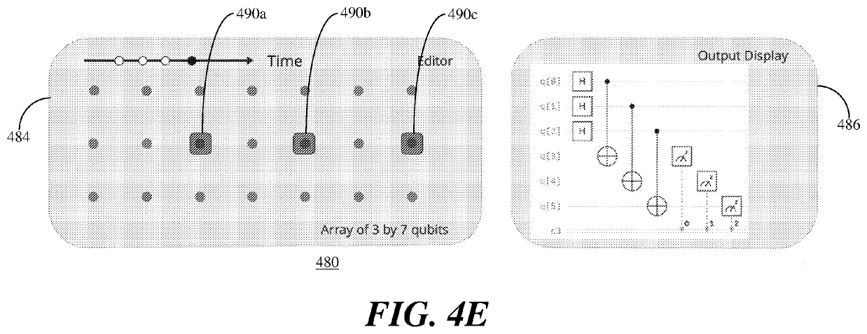

Referring to FIGS. 3A to 3E, illustrations 300, 320, 340, 360, 380 depict an example of a surface code design process in accordance with the present embodiments. Referring to the illustration 300, once the stabilizers 310 are properly set up in the editor 304, the tool can compute the type of boundaries as a topological feature where the nature of these boundaries define the logical qubit. The Output Display 306 displays the visual abstraction, i.e., the logical qubits 312 represented by squares with appropriate types of boundaries displayed as smooth or dashed lines.

Referring to the illustration 320, the user initializes a logical qubit on an array of physical qubits in the Editor 324 by positioning shaded squares on the grid in the Editor 324. The leftmost logical qubit 330 has been defined successfully. The tool informs the user of the successful definition of the qubit by helping the user to compute that all stabilizers 332 commute. However, the stabilizers in the rightmost attempted qubit definition 335 do not commute due to an identified ‘illegal operation’337.

Following on from the illustrations 300, 320, the illustration 340 depicts a simplified visual layout including a Palette 342 and an Editor 344 with which a user can interact to design a QEC code. The Editor 344 includes a grid 350 reflecting the layout of a hardware quantum processing unit (QPU). The grid 350 provides a reference point onto which a user can design the QEC code. The Palette 342 includes simple shapes 352 for qubit stabilizers that make up a QEC code. The user can select ones of these shapes 352 and place copies of them into the Editor 344, matching the corners of the shapes to the points of the grid.

The illustration 360 depicts a 2-step process for a merge operation in surface codes in accordance with the present embodiments. At Step 1 370, the user sets the initial state of ancillary qubits in the Editor 364a. The Output Display 366a displays the visual abstraction of the logical qubits. At Step 2 372, the user introduces new stabilizers 374 in the Editor 364b at the interface of the two logical qubits. The tool recognizes this as a logical operation, i.e., measurement of the ZZ operator. There is also a loss of one degree of freedom. The tool computes the output state for the user and displays it in the Output Display 366b.

The illustration 380 depicts another example of a 2-step merge operation where the user introduces, at Step 1 390, abstractions for two logical qubits into the Editor 384a. The tool outputs in the Output Display 386a the states of the two logical qubits. At Step 2 392, the user indicates in the Editor 384b that the merge operation be carried out on the two logical qubits. The tool computes by measurement of the ZZ operator the state q′ and presents it to the user in the Output Display 386b.

Referring to FIGS. 4A, 4B, 4C, 4D and 4E, illustrations 400, 420, 440, 460, 480 depict another exemplary quantum circuit design process in accordance with the present embodiments.

The illustration 400 depicts generating a Component made up internally of more Components. In the Editor 404a, the user connects components together. The tool outputs, in accordance with the present embodiments, a full circuit represented by the Components on the Output Display 406 in a visual representation chosen by the user. A Component 410 used in the circuit is designed by the user and is itself made up of more Components internally as shown in the Editor 404b. Such Components can be arbitrarily complex such as a Component designed for error correction.

The illustrations 420, 440, 460, 480 show time-separated steps in the building of a quantum circuit using the tool in accordance with the present embodiments. Beginning with the illustration 420, the user starts with an array of qubits, such as an array which mimics how qubits are arranged on some hardware. The Editor 424 includes a 3×7 array of qubits. In the first step depicted in the illustration 420, the user specifics which qubits to initialize or to use for the circuit. The tool then begins to display the circuit in the Output Display 426 in a time-sequence view.

Subsequently, in the illustration 440 the user switches to the next time step where the user specifies in the which qubits in the Editor 444 (noted as qubits 450a, 450b, 450c) will have some gates. And the tool updates the display of the circuit in the Output Display 446. At a next time step shown in the illustration 460, the user continues to specify gate operations (noted as gates 470a, 470b, 470c) and the tool updates the display of the circuit in the Output Display 466. And in a final time step depicted in the illustration 480, the user continues to specify gate operations (noted as gates 490a, 490b, 490c) and the tool updates the display of the circuit in the Output Display 486. In this manner, with the contemporaneous update of the display of the circuit in accordance with the methods and systems of the present embodiments, the user advantageously can immediately see the circuit definition as the user specifies various circuit operations. In addition, the tool provides one way to output visual representations of circuits, which is useful if the user needs to produce an overall image of the circuit.

The tool in accordance with the present embodiments has many applications and uses. For example, the tool could be used as an educational tool to teach concepts for designing FTQ circuits. An educator can use the tool to set up a fault-tolerant error correction circuit during lesson preparation. On the day of the lesson, the educator can load up the saved file and use the visual display of the circuit to explain how the circuit works. The educator can easily swap out different low-level components in the circuit to demonstrate alternative circuit designs or to show why a certain component is critical to the circuit.

The tool in accordance with the present embodiments also allows users to design and plan FTQ circuits to be run on hardware. In a physical device, there are additional constraints. The foremost difficulty is that physical systems implementing qubits have to be spatially spread out. However, the user may wish to implement a gate operation that connects one qubit to another that is far away. It is unavoidable to a certain degree that the quality of such operations will suffer as distance between pairs of qubits increases. Hence, there are methods for performing desired gate operations between distant qubits, such operations making use of other qubits together with additional gate operations. Such other qubits may be entirely auxiliary to the computation and play no other role other than to facilitate the desired gate operation, or they may also be part of the computation in some other capacity.

One method for overcoming connectivity constraints are operations that effectively swap the positions of qubits (SWAP gates) to bring a pair of qubits to a closer distance where the pairwise operation can be of higher quality. Nevertheless, SWAP operations also introduce additional noise to the computation and it is therefore imperative to minimize the number of SWAP operations. There are two main steps in achieving this. First, selecting physical qubits on the hardware carefully to represent qubits in the target quantum circuit can minimize the number of SWAP operations. For example, in simple QEC codes, some data qubits need to regularly interact with ancilla qubits. These ancilla qubits should therefore be physically located close to those data qubits on the chip and not located far away. The tool could be used to visualize different options for the mapping of qubits in the target circuit to qubits on the physical device. Secondly, the problem of minimizing the number of SWAP operations is commonly known as the qubit routing problem. One way to solve this problem is to use an optimization algorithm to find a quasi-optimal schedule for inserting the required SWAP gates into the target quantum circuit or assignment of qubit states to physical locations. However, the user may wish to visualize the representation of the solution and possibly edit the final circuit layout. The tool can advantageously provide such visualization. When the user has completed the design, the tool can then output the circuit in a standard format to be further processed into hardware instructions. In addition, further processing could be done separately by other software.

A further problem related to qubit connectivity is that of implementing encoded qubits on a large array of physical qubits, and performing encoded gate operations. For example, in surface code schemes, the encoded qubits occupy “regions” consisting of multiple physical qubits. There can be a need to perform a gate operation on a pair of encoded qubits that are spaced far apart from one another, or there can be a need to position a particular encoded qubit so that it is within a close distance to another set of encoded qubits. When these needs are mutually exclusive, then the user may need to either solve this as a constrained optimization problem or, perhaps, manually make a decision in favor of one need over another. There is also the additional difficulty that manipulations to swap positions of encoded information also need to be done in a way that does not destroy the protection offered by the error-correction code. The tool can make it easy for the user to see all of the relevant information at a glance, presented in a visually intuitive representation, in order to plan or edit circuits involving such a large number of qubits.

The tool in accordance with the present embodiments could further speed up the work of illustrators that need to create figures of specific FTQ circuits, such as fault-tolerant error-correction circuits for showcasing one's work. In addition, the tool in accordance with the present embodiments could be especially useful in designing one particular type of FTQ circuit, namely those consisting of logical operations with respect to quantum error correction codes. For example, the user may explore logical operations by interacting blocks (a collective group) of qubits together. There are common circuit operations that need to be maintained within each block qubit, such as syndrome measurements (which are measurement circuits for stabilizers of the error-correction code) and ancilla factories (which are a class of circuits dedicated to producing high-quality versions of certain types of quantum states).

This level of detail could be abstracted visually so that the user can focus on other details, such as the way two blocks of qubits interact may require some constraints to be obeyed. At the same time, the interaction of encoded information carried by the two blocks of qubits may be the only detail the user is concerned with, which means that the tool's ability to perform logical abstraction would be useful. As a concrete example, the user could design logical operations with respect to the surface code. In this scenario, the user might be interested in how logical qubits interact to perform a logical operation. In this case, the user needs to arrange patches of logical qubits on a 2D grid, and through an appropriation of lattice surgery operations, create a non-trivial circuit. Patches of logical qubits could be abstracted as rectangles (for example), while the required operations to make the rectangles interact with one another could be visually represented as how the rectangles join together along their borders. The user may also be concerned with how the physical qubits are sustained by continuous error-correcting cycles to maintain the surface code. In this case, the user can arrange stabilizers on the grid, and also add and remove stabilizers in turn, simply by arranging colored squares on a grid of objects representing an array of qubits.

The methods and systems in accordance with the present embodiments focuses on fault-tolerant aspects and structure of circuits by enabling a user to insert errors into a point in the circuit and visualize the effect of that error. Circuit properties relevant to fault-tolerance and error correction are also computed in the background and returned to the user in accordance with the methods and systems of the present embodiments, advantageously handling these tedious computations for the user. This allows the user to focus on the sole task of designing the circuit, swapping circuit components as he/she sees fit based on feedback and results automatically generated by the tool in accordance with the methods and system of the present embodiments.

Thus, it can be seen that the present embodiments provide systems and methods for efficient workflow for fast prototyping of quantum circuits. In addition, the methods and systems in accordance with the present embodiments focus on fault-tolerant aspects and structure of circuits by enabling a user to insert errors into a point in the circuit and visualize the effect of that error. Circuit properties relevant to fault-tolerance and error correction are also computed in the background and returned to the user in accordance with the methods and systems of the present embodiments, advantageously handling these tedious computations for the user. This allows the user to focus on the sole task of designing the circuit, swapping circuit components as he/she sees fit based on feedback and results automatically generated by the tool in accordance with the methods and system of the present embodiments.

While exemplary embodiments have been presented in the foregoing detailed description of the present embodiments, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing exemplary embodiments of the invention, it being understood that various changes may be made in the function and arrangement of steps and method of operation described in the exemplary embodiments without departing from the scope of the invention as set forth in the appended claims.

1. A computer-implemented method for enabling a user to design a quantum circuit, the method comprising:
presenting a user interface to the user, the user interface comprising a palette, an editor and an output display;
designing the quantum circuit in response to the user selecting one or more user interface representations of components and/or circuit operations presented in the palette and connecting a plurality of the one or more user interface representations of components and/or circuit operations in the editor in a user-assembled arrangement; and
computing circuit properties of the quantum circuit and displaying at least a portion of the circuit properties in the output display, wherein computing the circuit properties comprises determining if the quantum circuit is a valid quantum circuit.

2. The method in accordance with claim 1 wherein computing the circuit properties further comprises determining if the quantum circuit satisfies all conditions to be fault-tolerant.

3. The method in accordance with claim 2 further comprising, in response to determining that the quantum circuit does not satisfy all conditions to be fault-tolerant, presenting one or more error propagation paths on the user-assembled arrangement displayed in the editor, wherein presenting the one or more error propagation paths comprises presenting an indication of one or more uncorrectable faults in one or both of the editor or the display output.

4. The method in accordance with claim 3 wherein presenting the indication of the one or more uncorrectable faults in the display output comprises presenting an effective error at any point of the quantum circuit due to a fault introduced by the user into the quantum circuit.

5. The method in accordance with claim 1 further comprising, in response to determining that the quantum circuit is a valid quantum circuit:
computing a stabilizer array for the valid quantum circuit; and
determining that the computed stabilizer array matches a target stabilizer array.

6. The method in accordance with claim 5, wherein it is determined whether the quantum circuit satisfies all conditions to be fault-tolerant only when it is determined that the computed stabilizer array matches the target stabilizer array.

7. The method in accordance with claim 5 further comprising, in response to determining that the stabilizer array does not match the target stabilizer array, presenting to the user differences between the target stabilizer array and the computed stabilizer array.

8. The method in accordance with claim 7 further comprising:
receiving quantum circuit edits from the user in response to presenting the differences between the target stabilizer array and the computed stabilizer array; and
generating a redesigned quantum circuit in response to the quantum circuit edits.

9. The method in accordance with claim 8 wherein the quantum circuit edits comprise:
addition of one or more of the components and/or the circuit operations, and/or
deletion of one or more of the components and/or the circuit operations, and/or
replacement of one or more of the components and/or the circuit operations by other ones of the components and/or the circuit operations, and/or
swapping of one or more of the components with an adjacent one of the components.

10. (canceled)

11. (canceled)

12. (canceled)

13. The method in accordance with claim 8 further comprising determining if the redesigned quantum circuit is a valid quantum circuit.

14. A system for quantum circuit design comprising:
an interface for user-inputting information and for presenting output information; and
a processing means coupled to the interface for receiving the inputted information therefrom and for sending output information for presenting on a display of the interface, wherein the processing means is configured to
present a palette, an editor and an output display on the user interface;
design a quantum circuit in response to, receiving from the interface, selections of one or more user interface representations of components and/or circuit operations presented in the palette and receiving, from the interface, connections of a plurality of the one or more user interface representations of components and/or circuit operations in the editor in a user-assembled arrangement; and
compute circuit properties of the quantum circuit and provide display information to the interface to display at least a portion of the circuit properties in the output display, wherein computing the circuit properties comprises determining if the quantum circuit is a valid quantum circuit.

15. The system in accordance with claim 14 wherein the processing means is configured to determine if the quantum circuit satisfies all conditions to be fault-tolerant, when computing the circuit properties.

16. The system in accordance with claim 15 wherein, in response to determining that the quantum circuit does not satisfy all conditions to be fault-tolerant, the processing means is configured to provide information to the interface for the interface to present one or more error propagation paths on the user-assembled arrangement displayed in the editor, and to present an indication of one or more uncorrectable faults in one or both of the editor or the display output.

17. The system in accordance with claim 16 wherein the interface is configured to present an effective error at any point of the quantum circuit due to a fault introduced by the user into the quantum circuit, when presenting the indication of the one or more uncorrectable faults in the display output.

18. The system in accordance with claim 15 further comprising, in response to the processing means determining that the quantum circuit is a valid quantum circuit, the processing means being further configured to:
compute a stabilizer array for the valid quantum circuit; and
determine that the computed stabilizer array matches a target stabilizer array.

19. The system in accordance with claim 18, wherein the processing means is configured to determine that the quantum circuit satisfies all conditions to be fault-tolerant only when it is determined that the computed stabilizer array matches the target stabilizer array.

20. The system in accordance with claim 18 wherein, in response to the processing means determining that the stabilizer array does not match the target stabilizer array, the processing means is configured to forward information to the interface to display differences between the target stabilizer array and the computed stabilizer array.

21. The system in accordance with claim 20 wherein the processing means is further configured to generate a redesigned quantum circuit in response to quantum circuit edits received from the interface after presenting the differences between the target stabilizer array and the computed stabilizer array on the interface.

22. The system in accordance with claim 21 wherein the quantum circuit edits comprise:
addition of one or more of the components and/or the circuit operations, and/or
deletion of one or more of the components and/or the circuit operations, and/or
replacement of one or more of the components and/or the circuit operations by other ones of the components and/or the circuit operations, and/or
swapping of one or more of the components with an adjacent one of the components.

23. (canceled)

24. (canceled)

25. (canceled)

26. The system in accordance with claim 21 wherein the processing means is further configured to determine if the redesigned quantum circuit is a valid quantum circuit.
